(19) United States
(12) Patent Application Publication
(10) Pub. No.: US 2003/0084146 A1
(43) Pub. Date: May 1, 2003

(54) System and method for displaying network status in a network topology

(76) Inventors: Cynthia K. Schilling, Fort Collins, CO (US); Jun Su, Fort Collins, CO (US); Chia-Chu S. Dorland, Fort Collins, CO (US); Aaron J. Loyd, Fort Collins, CO (US); David S. Roth, Fort Collins, CO (US); Katherine L. Withers-Miklos, Fort Collins, CO (US)

Correspondence Address: HEWLETT-PACKARD COMPANY, Intellectual Property Administration, P. O. Box 272400, Fort Collins, CO, 80527-2400, US

(21) Appl. No.: 10/032,969

(22) Filed: Oct. 25, 2001

(51) Int. Cl. G06F 15/173; G09G 5/00

(52) U.S. Cl. 709/224; 345/736

(57) ABSTRACT

An electronic network is monitored by a plurality of diagnostic tools. When a first diagnostic tool determines that a portion of the electronic network is not operating within a preselected specification, at least one other diagnostic tool is instructed to analyze that portion of the network. The data generated by the diagnostic tools is correlated to better determine the cause of the network not operating within the preselected specification, which is then presented to a network user.

### FIELD OF THE INVENTION

The present invention generally relates to data communication networks and, more particularly, to a device and method for analyzing the operational status of a network and displaying data related to the operational status of the network.

### BACKGROUND OF THE INVENTION

A data communications network or an electronic network generally includes a group of devices, such as computers, repeaters, bridges, switches, routers, etc., situated at network nodes. A collection of communication channels interconnects the various nodes. Hardware and software associated with the network and, particularly, the devices, permit the devices to exchange data electronically via the communication channels.

Data communication networks vary in size and complexity. A local area network (LAN) is a network of devices that are in close proximity to each other. The LAN is typically less then one mile in length, and is usually connected by a single cable, for example, a coaxial cable. A wide area network (WAN) is a network of devices that are separated by longer distances. The devices in a WAN are often connected by communications devices such as telephone lines and satellite links. Some WANs span the distance of several countries. These networks may become very complex and may have numerous nodes and communication channels connecting a wide range of devices. Many of these networks are established for use by an entity, such as a university, a government entity, or a commercial industry. These entities have come to rely heavily on the networks and operate very inefficiently when a network fails.

Many management software packages are presently available for implementing “management stations” on a network. These management stations provide information relating to the devices attached to the network in addition to the operational status of the network. Some management stations provide a topographical display of the network with indications of operational problems detected. However, the management stations do not analyze data from different sources to determine the cause of specific problems with a network. Accordingly, the user of a management station has to review and analyze data from different sources in order to determine the root cause of a network problem. This analysis is time consuming and subject to errors.

Therefore there is a need for improved systems and methods which address these and other shortcomings of the prior art.

### SUMMARY OF THE INVENTION

The present invention is directed toward a device and method for analyzing the operational status of an electronic network. Data from a plurality of network monitoring and analysis tools is analyzed to monitor the network. The analysis of a plurality of different tools provides for a more accurate analysis of specific network problems. Data representative of the status of the network may then be displayed.

In one embodiment, the network monitoring and analysis tools are instructed to monitor or analyze a specific portion of the network based on the detection of a problem. Therefore, should one monitoring or analysis tool detect a problem with a portion of the network, other monitoring and analysis tools may be instructed to collect additional data corresponding to that portion of the network. The additional data provides for a greater analysis of network problems, which enables the user to better identify and correct the network problems.

### BRIEF DESCRIPTION OF THE DRAWINGS

FIG. 1 is a schematic illustration of an electronic network.

FIG. 2 is a flowchart illustrating a method of analyzing the operational status of the network of FIG. 1 according to an embodiment of the present invention.

FIG. 3 is a schematic illustration of an analysis system for analyzing the electronic network of FIG. 1 according to an embodiment of the present invention.

FIG. 4 is an embodiment of the analysis program of FIG. 3.

FIG. 5 is an embodiment of the analysis program of FIG. 3, wherein the analysis program causes diagnostic programs to analyze specific portions of the network of FIG. 1.

### DETAILED DESCRIPTION OF THE INVENTION

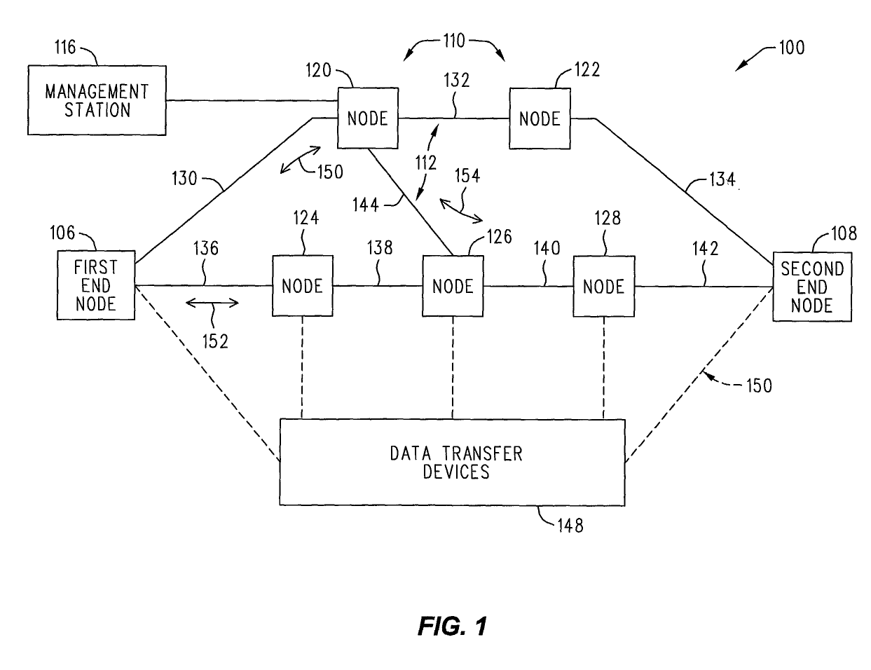

A non-limiting example of a network 100 is shown in FIG. 1. The network 100 shown in FIG. 1 is a very simple network and is provided for illustration purposes only. The network analysis system 100 provides for data communications between a first end node 106 and a second end node 108. In addition to the first end node 106 and the second end node 108, the network 100 may have a plurality of nodes 110 and data hops 112 connected therebetween. The nodes 110 described herein are virtually any device that facilitates the transfer of data within the network 100. A management station 116 may be connected to one of the nodes 110 and may serve to monitor and configure the network 100 as described in greater detail below. It should be noted that the management station 116 may alternatively be connected to either the first end node 106 or the second end node 108.

Having briefly described the network 100, it will now be described in greater detail. The network 100 provides for several data paths between the first node 106 and the second node 108 via the nodes 110 and the data hops 112. The network 100 of FIG. 1 has five nodes 110, which are individually referenced as the first node 120, the second node 122, the third node 124, the fourth node 126, and the fifth node 128. The data hops 112 are referred to individually as the first hop 130, the second hop 132, the third hop 134, the fourth hop 136, the fifth hop 138, the sixth hop 140, the seventh hop 142, and the eighth hop 144. In addition to the nodes 110 and the data hops 112 described above, other data transfer devices 148 and data hops 150 may be associated with the network 100.

The above-described nodes 110 and data hops 112 provide a plurality of data paths between the first end node 106 and the second end node 108. A first data path 150 extends between the first end node 106 and the second end node 108 via the first hop 130, the first node 120, the second hop 132, the second node 122, and the third hop 134. A second data path 152 extends between the first end node 106 and the second end node 108 via the fourth hop 136, the third node 124, the fifth hop 138, the fourth node 126, the sixth hop 140, the fifth node 128, and the seventh hop 142. A third data path 154 extends between the first end node 106 and the second end node 108 via the first hop 130, the first node 120, the eighth hop 144, the fourth node 126, the sixth hop 140, the fifth node 128, and the seventh hop 142. Other data paths, not specifically described herein, may extend between the first end node 106 and the second end node 108 via the data transfer devices 148 and the first data path 150.

The management station 116 may be a computer or other workstation operatively or otherwise electrically connected to the network 100. As described below, the management station 116 may serve to configure the components of the nodes 110 in addition to monitoring the operational status of the network 100. In one non-limiting embodiment of the network 100, the simple network management protocol (SNMP) is used for communications between the management station 116 and the nodes 110, including the first end node 106 and the second end node 108. Accordingly, the management station 116 is able to monitor the status of specific devices within the network 100 and to change the operating characteristics of the devices and, thus, the network 100 as a whole.

As described above, the data paths are used to transfer data between the first end node 106 and the second end node 108. Should one of the nodes 110 or one of the data hops 112 fail, the data paths associated therewith will fail. The network 100 has redundant data paths that facilitate the transfer of data. However, the data transfer rates will typically slow down due to the increased data traffic being carried by the remaining data paths. The slow down in data transfer rates is sometimes referred to as an increase in the response time or latency of the network 100.

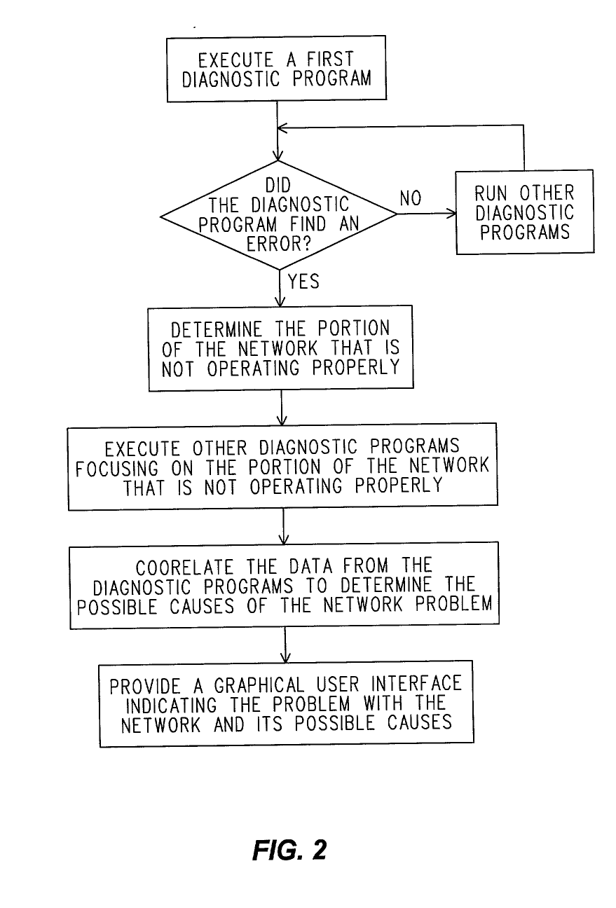

Having described the layout of the network 100, the method and device for analyzing the operational status of the network 100 will now be described. A flowchart illustrating a non-limiting embodiment of a method for analyzing the operational status of the network 100 is illustrated in FIG. 2. It should be noted that one embodiment of the device for analyzing the operational status of the network 100 is a computer that runs a program per the flowchart of FIG. 2. One embodiment of the method described herein receives data from a plurality of diagnostic programs or tools that may be running on the management station 116 or other nodes 110 within the network 100. The data generated by the plurality of diagnostic programs is analyzed to determine whether a parameter of the network is outside of a preselected specification, which is indicative of a problem with the network 100. The data may also be analyzed to determine the cause of the parameter operating outside of the preselected specification. In another embodiment of the network 100, after one of the diagnostic programs indicates that a problem exists with the network 100, the analysis program causes the other diagnostic programs to perform analysis on the portion of the network 100 that is not operating properly. The data is correlated to determine the possible causes of the network problem. A graphical user interface is then generated in order to inform the user of the problem with the network 100 and the possible causes of the problem.

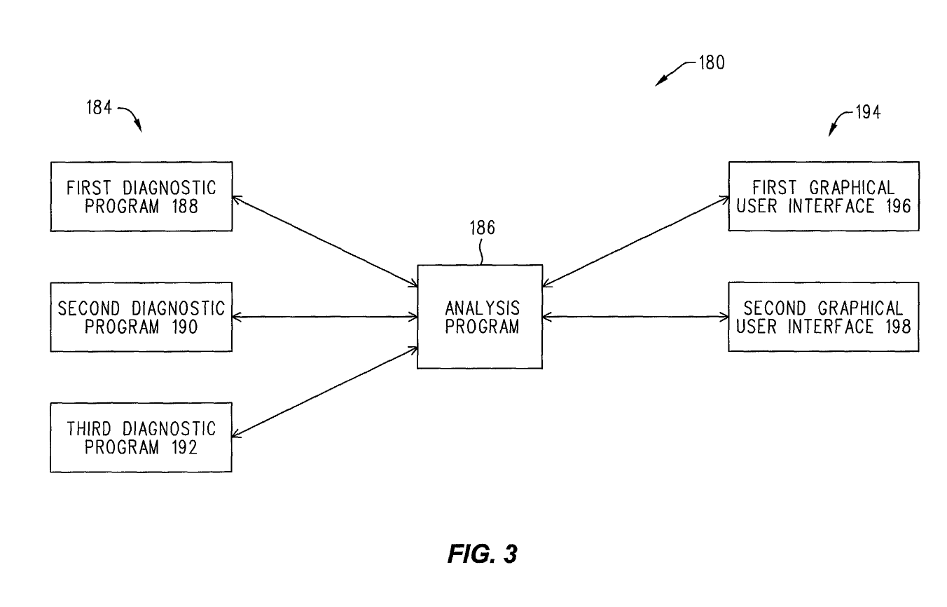

A non-limiting embodiment of a network analysis system 180 is illustrated in FIG. 3. The network analysis system 180 may have a plurality of diagnostic programs 184 operating in conjunction with an analysis program 186. In the non-limiting example described herein, there are three diagnostic programs 184 operating in conjunction with the analysis program 186. The three diagnostic programs 184 are referenced herein as the first diagnostic program 188, the second diagnostic program 190, and the third diagnostic program 192. The analysis program 186 may also operate in conjunction with a plurality of graphical user interfaces 194. In the non-limiting example of FIG. 2, two graphical user interfaces 194 are shown, a first graphical user interface 196 and a second graphical user interface 198.

With reference to FIGS. 1 and 3, the diagnostic programs 184 may perform different network diagnostics. For example, the first diagnostic program 188 may include procedures that, among other elements, monitor the operation of the network 100 overtime as described in the U.S. patent application, Ser. No. 09/915,070 of Loyd, filed on Jul. 25, 2001 for a METHOD AND DEVICE FOR MONITORING THE PERFORMANCE OF A NETWORK (attorney docket number 10006615-1), which is hereby incorporated by reference for all that is disclosed therein. The second diagnostic program 190 may include procedures that, among other elements, monitor the operation of the network 100 by analyzing nodes on certain paths as described in the United States patent application, serial number ______ of Jeffrey Conrad et al., filed on the same date as this application for SYSTEM AND METHOD FOR DETERMINING NETWORK STATUS ALONG SPECIFIC PATHS BETWEEN NODES IN A NETWORK TOPOLOGY (attorney docket number 10006661-1), which is hereby incorporated by reference for all that is disclosed therein. The third diagnostic program 192 may include procedures that, among other elements, monitor the operation of the network 100 by continually measuring various response times as is described in the U.S. patent application, Ser. No. 09/925,861 of Richardson for METHOD FOR AUTOMATICALLY MONITORING A NETWORK (attorney docket number 10002169-1) filed on Aug. 9, 2001, which is hereby incorporated by reference for all that is disclosed therein. It is to be understood that other diagnostic programs, not described herein, may be operatively connected otherwise associated with the analysis program 186.

The diagnostic programs 184 may monitor specific portions or specific parameters of the network 100 and may generate data representative of the operational status of the network 100. More specifically, the data may be representative of the operation of a portion of the network 100, such as the time response of a data path. The data may also be representative of a parameter of the network 100, such as the amount of data passing through a specific node. As described above, the first diagnostic program 188 may monitor the operational status of the network 100 over a time period to generate operational specifications that change over time. For example, the first diagnostic program 188 may monitor the time response or latency between the first end node 106 and the second end node 108. The first diagnostic program 188 may determine that during certain times of the day, the latency increases. The first diagnostic program 188 may then adjust the operational specification of the network 100 to accommodate this increased latency. Should the latency increase beyond the specification, the first diagnostic program 188 may generate a fault indication that is provided to the analysis program 186. The first diagnostic program 188 may also generate a fault indication if the latency undergoes a dramatic increase, which is indicative of one of the nodes 110 suddenly failing. It should be noted that in one embodiment, the data analysis may be achieved by the analysis program 186 rather than the first diagnostic program 188. Accordingly, the first diagnostic program 188 may output raw data to the analysis program 186.

The second diagnostic program 190 may determine the probable paths between the first end node 106 and the second end node 108 and monitor the nodes 110 located on the probable data paths. The second diagnostic program 190 has the advantage of assigning parameter values to the nodes 110 based on the type of nodes 110 located in the paths. For example, one type of router may have preselected parameter specifications assigned to it. Should one of the routers in the path exceed these specifications, the second diagnostic program 190 may generate a fault indication. It should be noted that in one embodiment, the preselected parameter specifications may be transmitted by the analysis program 186 to the second diagnostic program 190. Accordingly, the analysis program 186 establishes the criteria for the second diagnostic program 190 to generate a fault indication.

The third diagnostic program 192 may repeatedly monitor the time response or latency between the first end node 106 and the second end node 108. The measured time responses are then compared to a preselected value. Should a measured time response or a plurality of measured time responses exceed the preselected value, a fault notification is generated. It should be noted that different embodiments of the measured value and the preselected value may be used. For example, the measured value may actually be an average of values measured over a preselected period. Likewise, the preselected value may be the mean of a preselected number of measured values. As with the second diagnostic program 190, the first diagnostic program 188 may transmit the preselected values to the third diagnostic program 192 and, thus, may establish the criteria for the third diagnostic program 192 to generate a fault indication.

It should be noted that the diagnostic programs 184 described above may transmit data rather than fault indications to the analysis program 186. Accordingly, the analysis program 186 may analyze the data generated by the diagnostic programs 184 to determine whether the network 100 is operating within preselected specifications. In either embodiment, the analysis program 186 provides a notification of the fault via the graphical user interfaces 194. All the data accumulated by the analysis program 186 may be capable of being displayed via the graphical user interfaces 194 so that the user is able to determine the cause of the fault. As described in greater detail below, the analysis program 186 may initiate troubleshooting procedures by causing the diagnostic programs 184 to further analyze the portion of the network 100 that may be experiencing a fault. Thus, the analysis program 186 is able to function in real time and may operate using demand based diagnostics, wherein the diagnostics are run as required. It should also be noted that the analysis program 186 may interface with a plurality of different diagnostic programs.

Having generally described the analysis program 186, an embodiment of the operation of the analysis program 186 will now be described in greater detail.

In summary, a network-based communication is established with at least one of the tools that generates fault detection data and other data pertaining to the operation of the network. The tools may be programs that are executed on the nodes of the network as described above. Information pertaining to a portion or parameter of the network may be actively requested from these tools. The data generated by the tools may be requested and transmitted within the network by a variety of methods, such as a network socket connection, an http request, or a servlet request.

The data generated by the tools may be analyzed, formatted, and displayed in a user-intuitive fashion. For example, should the analysis of the data indicate a problem with the network, the problem may be displayed so that a user can easily identify the problem and the cause of the problem. Some of the data may be displayed verbatim as raw data. For example, actual response times within the network may be displayed. Some embodiments transform the data into a format that is easier and quicker to interpret by the user. For example, response times between zero and fifteen milliseconds may be displayed as NORMAL. Response times between sixteen and thirty milliseconds may be displayed as HIGH. Response times greater than thirty milliseconds may be displayed as DANGEROUSLY HIGH. Other display schemes, such as color coding may also be employed.

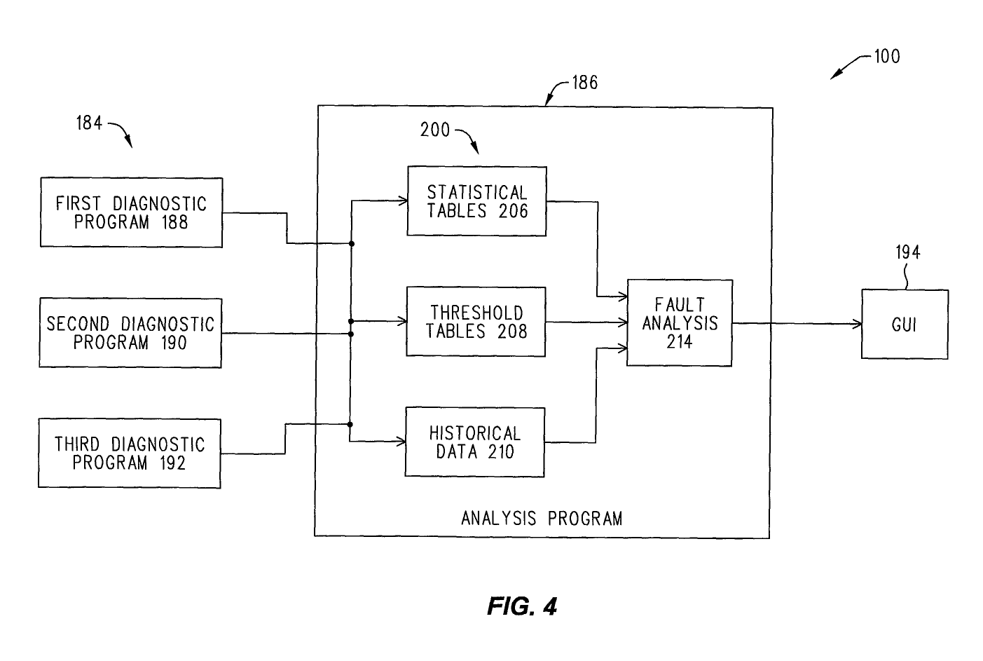

A block diagram of this embodiment of the analysis program 186 is shown in FIG. 4. The analysis program 186 of FIG. 4 receives data from the diagnostic programs 184 arid applies different analysis tools 200 to the data. The data may, as non-limiting examples, be fault indications or raw data generated by the diagnostic programs 184. The analysis tools 200 in the non-limiting embodiment described herein include statistical tables 206, threshold tables 208, and historical data 210. A fault analysis tool 214 analyzes data generated by the analysis tools 200 to determine whether a fault exists within the network 100, FIG. 1, and where in the network 100 the fault is located.

The statistical tables 206 may be used to compare the data generated by the diagnostic programs 184 to statistical tables to determine whether the program is operating within preselected specifications. With additional reference to FIG. 1, the statistical tables 206 in conjunction with the fault analysis tool 214 may determine that a fault detected with the time responses of specific data hops 112 means that specific nodes 110 within the network 100 are likely not operating properly. For example, the fault analysis tool 214 may compare data generated by the statistical tables 206 with preselected values to determine whether the network 100 is operating within preselected parameters. The graphical user interfaces 194 may then display this data to the user of the network 100. The data may, as an example, indicate the likely causes of the time response problems in addition to the data accumulated by the analysis program 186.

The threshold tables 208 may be used to compare the data generated by the diagnostic programs 184 to preselected threshold values. The threshold values may cover a wide range of parameters that are analyzed by the diagnostic programs 184. These parameters may include latency values of data paths including specific portions of data paths. In addition, the parameters may also include specific operating characteristics of the individual data transfer devices 110, such as data storage space and data traffic. The threshold tables 208 may output data indicating the parameter that has exceed the preselected threshold, the measured data value, and the threshold value.

The historical data 210 may be used to compare data generated by the diagnostic programs 184 to historical data accumulated over time. The historical data 210 may operate in a manner similar to the patent application, serial number ______ of Loyd, filed on ______ for a METHOD AND DEVICE FOR MONITORING THE PERFORMANCE OF A NETWORK, previously referenced. This embodiment of the historical data 210 identifies parameters in the network 100 that change over time and accounts for the changes. Accordingly, the historical data 210 may account for high latency at preselected times of the day when the network 100 experiences the heaviest usage. Thus, fault indications will not be generated when the network 100 is experiencing an expected high latency.

In another embodiment, the historical data 210 is used to compare the results of the diagnostic programs 184 to previously identified problems with the network 100. For example, the historical data 210 may include several data bases that correlate data of network parameters to specific problems within the network 100. Accordingly, the historical data 210 may compare fault information or data generated by the diagnostic programs 184 to the data bases in order to determine if the operating problem of the network 100 has existed in the past. The historical data 210 then displays the causes of the previously detected problem. In one embodiment, the user may manually determine the cause or causes of a network problem based on fault information generated by the analysis program 186. This information may be input into the historical data 210 to facilitate the resolution of similar network problems in the future.

As described above, the analysis program 186 is able to analyze data from a plurality of the diagnostic programs 184 in order to accurately determine the cause of a problem within the network 100. For example, the third diagnostic program 192 may generate data indicating that the time response between the first end node 106 and the second end node 108 is too high. The third diagnostic program 192 may provide data further indicating that the problem is associated with the sixth hop 140 between the fourth node 126 and the fifth node 128. Concurrently, the second diagnostic program 190 may generate data indicating that the latency associated with the fourth node 126 and the fifth node 128 are high. The first diagnostic program 188 may generate data indicating that the latency associated with the paths between the first end node 106 and the second end node 108 is unexpectedly high.

The above-described data generated by the diagnostic programs 184 may be analyzed by the analysis program 186 to provide an indication as to the cause of the increased latency. The analysis tools 200 may be used to analyze the data generated by the diagnostic programs 184 and to provide data to the fault analysis tool 214 as to the problem with the network 100. For example, the statistical tables 206 may be used to identify which nodes 110 within the network 100 is likely to cause the diagnostic programs 184 to generate specific fault data. The threshold tables 208 may be used to identify the problem based on comparing the data to preselected thresholds. For example, values of operational parameters may be compared to preselected thresholds to determine if portions of the network 100 or nodes 110 within the network 100 are not operating within the preselected thresholds. The historical data 210 may be used to determine whether the data generated by the diagnostic programs 184 has ever occurred in the past.

The data generated by the analysis tools 200 is output to the fault analysis tool 214 to provide indications as to the possible problems with the network 100. For example, all the analysis tools 200 may indicate that a problem exists with the fifth node 128 and some of the analysis tools 200 may indicate that a problem exists with the fourth node 126. The fault analysis tool 214 may then cause the graphical user interfaces 194 to display data indicating that a problem likely exists with the fifth node 128 or the fourth node 126. The data may include information further indicating that the most likely cause of the problem is the fifth node 128.

Having described one embodiment of the network 100, other embodiments will now be described.

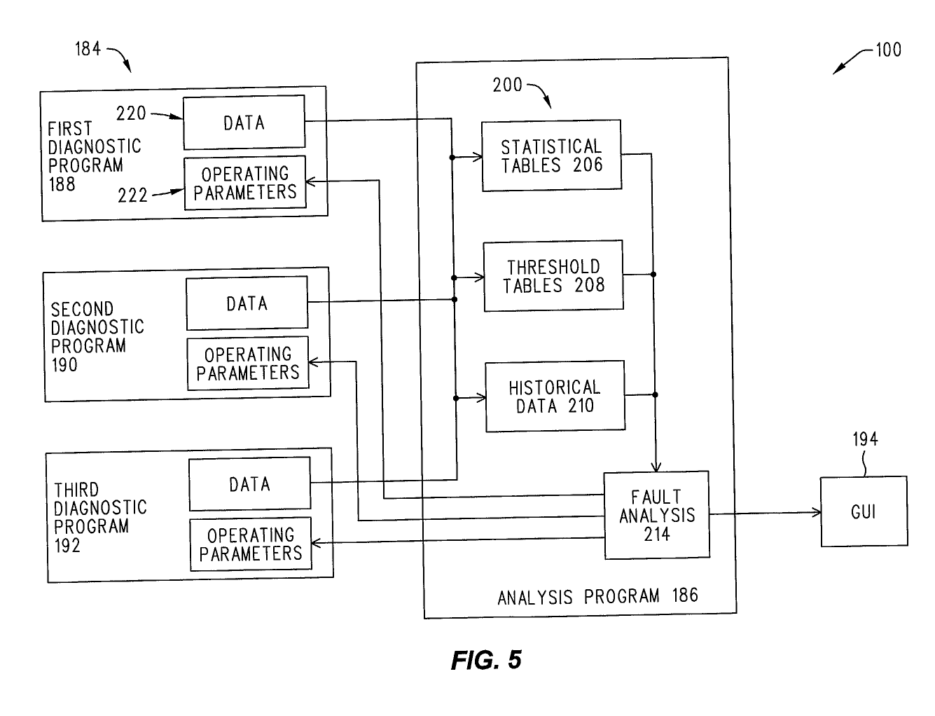

As briefly described above, the analysis program 186 may receive data from the diagnostic programs 184 and may cause the diagnostic programs 184 to analyze portions of the network that are possibly experiencing problems. An example of this configuration of the network 100 is shown in the block diagram of FIG. 5. Each of the diagnostic programs 184 may have a data output 220 associated therewith. Additionally, each of the diagnostic programs 184 may have an input for receiving operating parameters 222 from the analysis program 186. The operating parameters 222 serve as inputs to control the operation of the diagnostic programs 184 and to instruct the diagnostic programs 184 to analyze a specific portion or parameter of the network 100. For example, with regard to the above-described network problem, only one of the diagnostic programs 184 may have initially determined that a problem exists with regard to the fourth node 126 and the fifth node 128. The fault analysis tool 214 may then output data to the operating parameters 222 in the remaining diagnostic programs 184 which causes the remaining diagnostic programs 184 to analyze the network 100 associated with the fourth node 126 and the fifth node 128. The data generated by the diagnostic programs 184 is then output by the data outputs 220 to be analyzed by the analysis tools 200 in conjunction with the fault analysis tool 214 as described above.

With regard to the example described above, the third diagnostic program 192 may determine that the latency in the second data path 152 is too high. The fault analysis tool 214 may analyze the data and output data to the first diagnostic program 188 and the second diagnostic program 190 causing them to analyze the network 100 associated with the fourth node 126 and the fifth node 128. For example, the first diagnostic program 188 may be instructed to determine if the response times associated with either the fourth node 126 or the fifth node 128 have increased unexpectedly. Likewise, the second diagnostic program 190 may analyze the operation of the fourth node 126 and the fifth node 128 to determine if they are operating properly. If the first diagnostic program 188 and the second diagnostic program 190 determine that the network 100 is operating properly, the fault analysis tool 214 may update the analysis tools 200. The update to the analysis tools 200 will cause the analysis tools 200 to accept the data of the third diagnostic program 192 that was previously out of specification as being within specification.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A method for monitoring the status of an electronic network, said method comprising:
executing a first program on at least one portion of said electronic network;
receiving first data resulting from the execution of said first program;
analyzing said first data to determine if said at least one portion of said network is not operating within a preselected specification;
executing a second program on said at least one portion of said electronic network if the analysis of said first data indicates that said at least one portion of said electronic network is not operating within said preselected specification;
receiving second data resulting from the execution of said second program; and
analyzing said first data and second data to determine the cause of said at least one portion of said network not operating within said preselected specification.

2. The method of claim 1, wherein said executing a first program comprises measuring the latency associated with said at least one portion of said electronic network.

3. The method of claim 1, wherein said at least one portion of said network has a connector associated therewith, said connector storing a management information base, and wherein said executing a first program comprises measuring data stored in said management information base.

4. The method of claim 1, wherein said executing a first program comprises performing at least two measurements of a parameter of said network, and wherein said first data provides an indication of said network not operating within a preselected specification if the difference of said at least two measurements exceeds a preselected amount.

5. The method of claim 1, wherein said first program stores correlations between previous network conditions and previous network problems, and wherein said executing a first program comprises comparing present network conditions to stored network conditions and determining a network problem based at least in part on the comparison.

6. The method of claim 1, wherein said executing said first program comprises running at least one trace route routine on said at least one portion of said network, said trace route routine measuring the latency of said at least one portion of said network.

7. The method of claim 1, wherein said executing said first program comprises running a trace route routine a first time and a second time on said at least a portion of said network, said trace route routine measuring the latency of said at least one portion of said network, said first data corresponding to the difference between the latency measured said first time and said second time said trace route routine is run.

8. The method of claim 1 and further comprising displaying a graphical user interface representative of said network, said graphical user interface indicating said portion of said network not operating within said preselected specification.

9. The method of claim 8, wherein said graphical user interface further displays information relating to at least one cause of said network not operating within said preselected specification.

10. A device for evaluating the operational status of an electronic network, said device comprising a computer operatively connected to said network, said computer comprising a computer-readable medium having instructions for operating said computer and evaluating said network by:
executing a first program on at least one portion of said electronic network;
receiving first data resulting from the execution of said first program;
executing a second program on said at least one portion of said electronic network if the analysis of said first data indicates that said at least one portion of said electronic network is not operating within said preselected specification;
receiving second data resulting from the execution of said second program; and
analyzing said first data and second data to determine the cause of said at least one portion of said network not operating within said preselected specification.

11. The device of claim 10, wherein said executing a first program comprises measuring the latency associated with said at least one portion of said electronic network.

12. The method of claim 10, wherein said at least one portion of said network has a connector associated therewith, said connector storing a management information base, and wherein said executing a first program comprises measuring data stored in said management information base.

13. The method of claim 10, wherein said executing a first program comprises performing at least two measurements of a parameter of said network, and wherein said first data provides an indication of said network not operating within said preselected specification if the difference of said at least two measurements exceeds a preselected amount.

14. The method of claim 10, wherein said first program stores correlations between previous network conditions and previous network problems, and wherein said executing a first program comprises comparing present network conditions to stored network conditions and determining a network problem based at least in part on the comparison.

15. The method of claim 10, wherein said executing said first program comprises running at least one trace route routine on said at least one portion of said network, said trace route routine measuring the latency of said at least one portion of said network.

16. The method of claim 10, wherein said executing said first program comprises running a trace route routine a first time and a second time on said at least a portion of said network, said trace route routine measuring the latency of said at least one portion of said network, said first data corresponding to the difference between the latency measured said first time and said second time said trace route routine is run.

17. The method of claim 10 and further comprising displaying a graphical user interface representative of said network, said graphical user interface indicating said portion of said network not operating within said preselected specification.

18. The method of claim 17, wherein said graphical user interface further displays information relating to at least one cause of said network not operating within said preselected specification.

19. A device for monitoring the status of an electronic network, said device comprising:
first diagnostic means for executing a first diagnostic program on at least one portion of said electronic network, said first diagnostic program generating first data representative of the status of said at least one portion of said electronic network;
first analysis means for analyzing said first data;
second diagnostic means for executing a second diagnostic program on at least one portion of said electronic network if said first analysis means determines that said at least one portion of said electronic network is not operating within a preselected specification, said second diagnostic program generating second data representative of the status of said at least one portion of said network; and
second analysis means for analyzing said first data and said second data, said second analysis means generating an indication representative of the cause of said at least one portion of said electronic network not operating within said preselected specification.
